(19) United States
(12) Patent Application Publication
(10) Pub. No.: US 2004/0060999 A1
(43) Pub. Date: Apr. 1, 2004

(54) Injection vaporizer

(75) Inventor: Mikael Kock, Akersberga (SE)

Correspondence Address: SCHIFF HARDIN, LLP, PATENT DEPARTMENT, 6600 SEARS TOWER, CHICAGO, IL, 60606-6473, US

(73) Assignee: Siemens-Elema AB

(21) Appl. No.: 10/663,951

(22) Filed: Sep. 16, 2003

(30) Foreign Application Priority Data
Sep. 25, 2002 (SE) 0202832-2

(51) Int. Cl. B05C 1/00; B05B 1/24; B05B 7/16

(52) U.S. Cl. 239/136; 239/135; 239/128

(57) ABSTRACT

An injection vaporizer has a reservoir for liquid to be vaporized and a delivery conduit connected to the reservoir with an outlet for injecting liquid to be vaporized into a gas space, formed by a flow-through chamber. A pumping system is operable to transfer liquid from the reservoir to the outlet. A heater supplies thermal energy into the delivery conduit. A pressure generator generates an elevated delivery pressure within the delivery conduit and is operable with the heater to establish a heated pressurized liquid at the outlet.

### BACKGROUND OF THE INVENTION

1. Field of the Invention

The present invention relates to an injection vaporizer and in particular to an injection vaporizer for admixing a liquid anaesthetic and a breathing gas.

2. Description of the Prior Art

Injection vaporizers are well known and operate by direct injection of a volatile liquid, such as liquid anaesthetic, into a gas flow, such as a breathing gas flow intended for delivery to a patient. Generally, the known injection vaporizers have a pump system connected to a reservoir for liquid to be vaporized and to a delivery conduit. Liquid is transferred into the delivery conduit by the pump system and from there it is injected through an outlet and into the gas flow within a gas space wherein it vaporizes. One example of such an injection vaporizer is disclosed in U.S. Pat. No. 5,242,403. The vaporizer disclosed therein is specially adapted for low boiling-point liquids and additionally has a cooling device to maintain the temperature of the liquid, particularly within the reservoir and the pumping device, below boiling-point. Since this cooling makes it more difficult for the liquid to vaporize, a heating device is provided to supply thermal energy into the delivery conduit to vaporize the liquid therein. This has the disadvantage that metering of doses of the volatile liquid may become more inaccurate due to the presence of a mixture of vapor and liquid within the delivery conduit.

### SUMMARY OF THE INVENTION

The above object is achieved in accordance with the invention in an injection vaporizer of the type described above, having a pressure regulator that generates an elevated pressure within the delivery conduit, and that cooperates with the heater, to establish a heated, pressurized liquid at the outlet.

By providing a pressure generator that operates in co-operation with a heater in thermal contact with liquid within the delivery conduit, a pressurized heated liquid can be established at the outlet of the delivery tube, preferably heated to a temperature of at least the boiling point of the liquid, at a pressure that exists externally of the outlet of the delivery conduit. This aids the rapid volatilization of the liquid in the gas space into which it is injected and also enables a more accurate metering of the injected liquid.

### DESCRIPTION OF THE DRAWINGS

FIG. 1 is a schematic block diagram of a first embodiment of a vaporizer according to the present invention.

FIG. 2 is a schematic illustration of a pressure regulator usable in the vaporizer according to the present invention.

FIG. 3 is a schematic block diagram of a second embodiment of a vaporizer according to the present invention.

### DESCRIPTION OF THE PREFERRED EMBODIMENTS

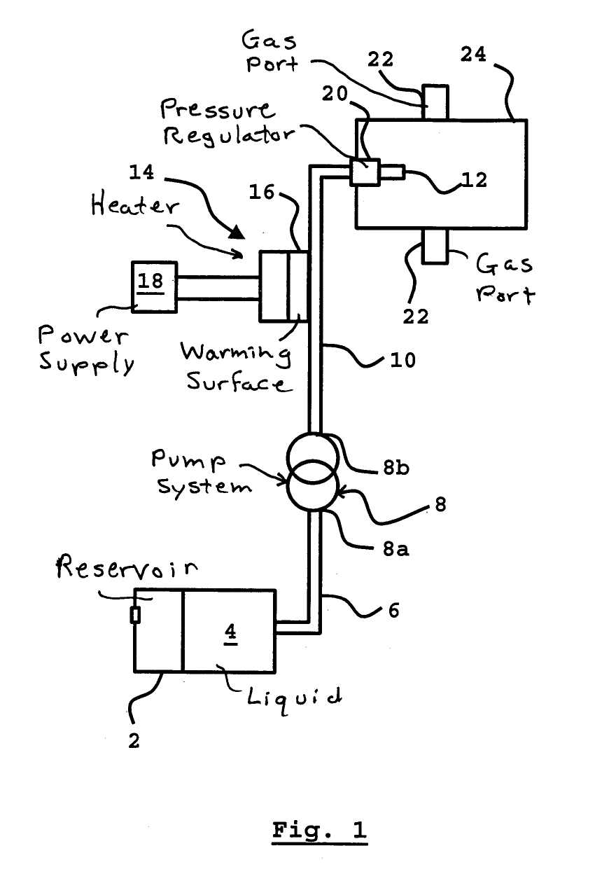

As shown in FIG. 1, a vaporizer has a reservoir 2 for liquid 4 to be vaporized connected by a feed conduit 6 to an inlet 8a of a pump system 8 which has an outlet 8b connected to a delivery conduit 10. The delivery conduit 10 has an outlet 12 that extends into a gas space, provided in the present example by a chamber 24, and provides for injection of liquid 4 from the reservoir 2 into the chamber 24. The chamber 24, in the present example, is provided with gas ports 22 by which a flow of gas to be admixed with vaporized liquid will enter and exit the chamber 24.

A heater 14, such as a Peltier heater, is located with its warming surface 16 in good thermal contact with at least a section of the delivery conduit 10 and is energizable by a power supply 18 to supply thermal energy into the vaporizable liquid within the delivery conduit 10. A pressure regulator 20 is located in fluid communication with the outlet 12 of the delivery conduit 10 and is operable to inhibit injection of liquid 4 into the gas space formed by the chamber 24 until a desired delivery pressure of liquid within the conduit 10 is established.

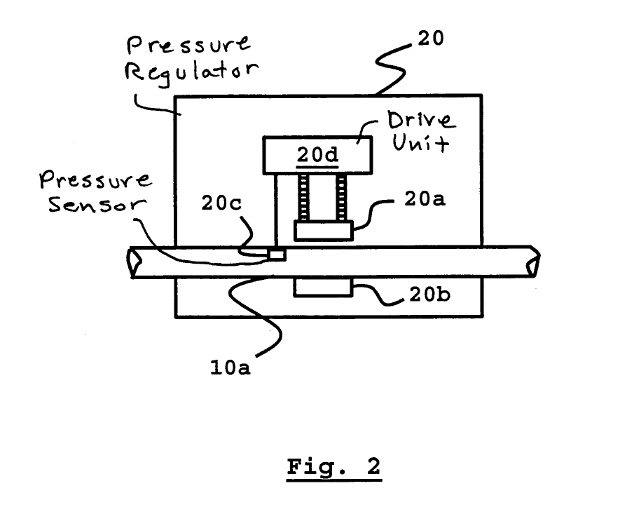

An example of a pressure regulator 20 that may be employed in the vaporizer of FIG. 1 is depicted in FIG. 2. As is illustrated in FIG. 2, the pressure regulator 20 may be formed as a so-called “pinch” or “clamp” type valve that has relatively movable jaws 20a and 20b between which is located a resiliently deformable wall section 10a of the delivery conduit 10. This wall section 10a may be formed integrally with the delivery conduit 10, as in the present embodiment, or may form a separate conduit section, for example provided as a part of the pressure regulator 20, that is attachable in-line with the remainder of the delivery conduit 10. A pressure sensor 20c is provided as part of the regulator 20 and is arranged to sense pressure within the delivery conduit 10, preferably proximal the jaws 20a and 20b. The pressure sensor 20c is configured to provide an output to a drive unit 20d, such as a stepper drive, of the regulator 20 which is operably connected to the movable jaws 20a and 20b so as to be able to move one or both jaws 20a and 20b into or out of contact with the deformable conduit section 10a in response to the pressure sensed by the pressure sensor 20c.

Returning now to the exemplary vaporizer of FIG. 1, in use the pumping system 8 is operated to generate a pressurized flow of liquid 4 from the reservoir 2 and toward the outlet 12 of the delivery conduit 10. The pressure regulator 20 is configured to maintain the outlet 12 sealed until the pressure of liquid 4 within the delivery conduit 10 reaches an elevated, predetermined delivery pressure. The heater 14 supplies thermal energy into the delivery conduit 10 to raise the temperature of the liquid therein to a level below its boiling point at the elevated delivery pressure, and preferably to a level above its boiling point at ambient pressure within the chamber 24. As the heated pressurized liquid exits through the outlet 12 its pressure is reduced and the supplied thermal energy aids in the volatilization of the liquid in a gas stream flowing through the chamber 24. The delivery pressure and the maximum temperature to which the heater 14 elevates the liquid 4 are thus closely inter-related and depend in a known manner on the thermodynamic properties of the liquid 4 to be volatilized.

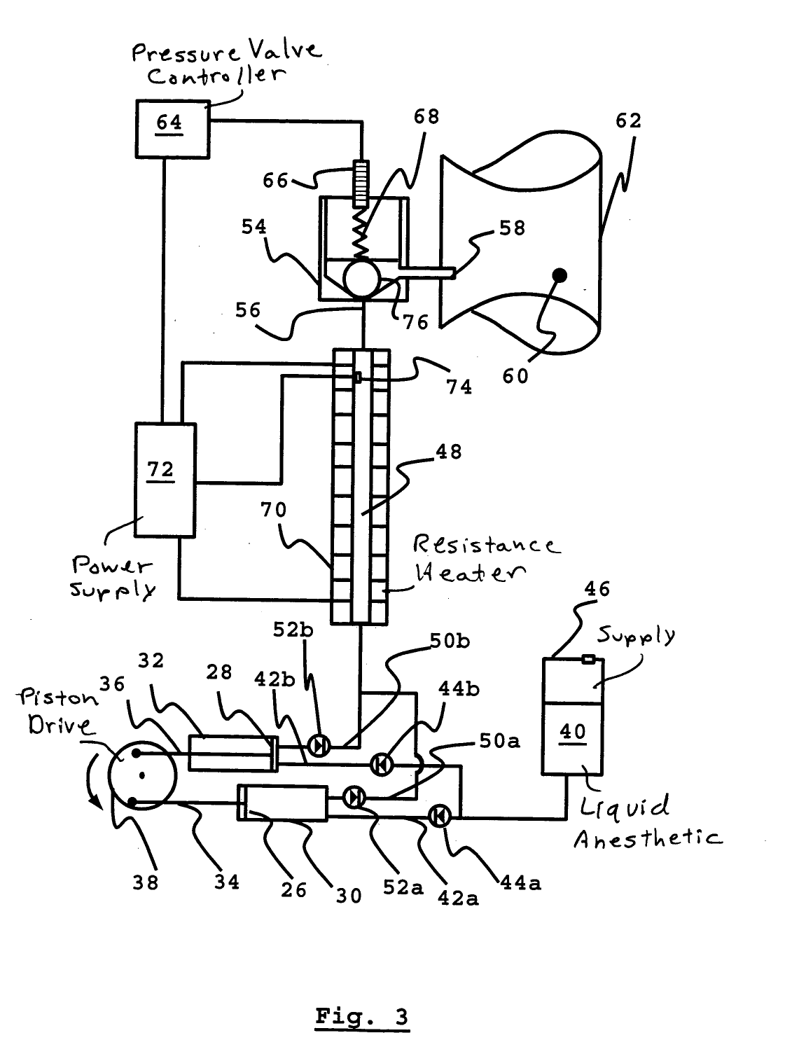

In the vaporizer of FIG. 3, each of a pair of pistons 26,28 is arranged for reciprocal displacement within an associated chamber 30,32 to act as a pumping system. Each piston 26,28 is connected via an associated rod 34,36 to a drive 38 in a manner such that, in this example, their reciprocating pump strokes have a relative phase difference of substantially 180 degrees. The chambers 30,32 act as a reservoir for a liquid anaesthetic 40 to be vaporized and are each connectable via, in this example, respective feed lines 42a and 43b and respective one-way valves 44a and 43b, located in the respective feed lines 42a and 43b, to a supply 46 of the liquid anaesthetic 40. The one-way valves 44a and 43b are each configured to permit liquid flow in one direction only, namely from the supply 46 to the respective refill the chambers 30,32 as necessary. Each chamber 30,32 is also connected to a delivery conduit 48 via, in this example, respective feed lines 50a and 50b and respective one-way valves 52a and 52b located in a respective feed lines 50a and 50b and configured to permit liquid flow in one direction only, namely from the respective chambers 30,32.

In the vaporizer embodiment of FIG. 3, a pressure regulator, here in the form of a back pressure valve 54 of a known “ball-and-spring” type, is located in fluid communication with an open end 56 of the delivery conduit 48. The pressure valve 54 is, in this example, provided with a port 58 that forms the outlet of the delivery conduit 48 and that opens into a gas space 60, here formed by a section 62 of a pneumatic circuit of a mechanical breathing aid (not shown), through which a breathing gas to be delivered to a patient is intended to flow. The pressure valve 54 is configured to seal the outlet port 58 against excape of the liquid anaesthetic 40 until a liquid pressure within the delivery conduit 48, generated by the pistons 26,28, reaches a desired elevated delivery pressure. At this time the pressure valve 54 operates to unseal the outlet port 58 and thus permit the injection of heated, pressurized liquid anaesthetic 40 through the port 58 into the gas space 60 where it vaporizes. As shown in FIG. 2, the delivery pressure set by the pressure valve 54 is adjustable by means of a controller 64, that here operates a stepper motor 66, to adjust the tension of the spring 68 of the ball-and-spring arrangement. A desired delivery pressure may be entered by a user directly into the controller 64 via a user interface such as a keyboard, touch screen or cursor device and graphic display. Alternatively, the liquid anaesthetic 40 to be delivered may be identified by the user to the controller 64 which may then be provided with a look-up table stored in an internal memory, in which each of one or more liquid anaesthetics is indexed with a desired delivery pressure (for example a pressure at which the selected anaesthetic remains liquid at a predetermined elevated temperature) to thereby automatically establish a desired delivery pressure.

A heater, here in the form of an elongate helical coil resistance heater 70, is located in thermal contact around at least a portion of the delivery conduit 48 and is energizable by a power supply 72 to supply thermal energy into pressurized liquid within the delivery conduit 48. In this example the power supply 72 is controllable in response to signals from a thermal sensor 74, disposed within the delivery conduit 48, and also by an output from the pressure valve controller 64, indicating the predetermined temperature to which the liquid anaesthetic within the conduit 48 is to be heated. This predetermined temperature is associated with the elevated delivery pressure to be established by the valve 54 at which the heated anaesthetic within the conduit 48 will remain liquid, but at which the heated anaesthetic will be at a atemperature approximating, preferably above, its boiling point within the gas space 60. Preferably, the heater 70 may be arranged to also heat the valve 54, and in particular the ball 76 of the ball-and spring arrangement which represents a relatively large heat sink in contact with heated anesthetic 40. This better ensures that the anesthetic 40 present at the port 58 remains heated to about its boiling point at the pressure within the section 62 of the pneumatic circuit into which the port 58 opens.

In use, and as also described with respect to the vaporizer of FIG. 1, the heated pressurized liquid anaesthetic 40 is injected into the gas space 60, the reduced pressure and the supplied thermal energy aids in the rapid vaporization of the liquid anaesthetic in the breathing gas within the section 62 of the pneumatic circuit.

Although modifications and changes may be suggested by those skilled in the art, it is the intention of the inventor to embody within the patent warranted hereon all changes and modifications as reasonably and properly come within the scope of his contribution to the art.

I claim as my invention:

1. An injection vaporizer comprising:
a reservoir for liquid to be vaporized;
a delivery conduit having an outlet for injecting liquid to be vaporized into a gas space;
a pumping system operable to transfer liquid from the reservoir to the outlet;
a heater for supplying thermal energy into the delivery conduit; and
a pressure generator for generating an elevated delivery pressure within the delivery conduit and cooperating with the heater to establish a heated pressurized liquid at the outlet.

2. A vaporizer as claimed in claim 1 wherein the pressure generator comprises a pressure regulator in fluid communication with the outlet and responsive to pressure levels within the delivery conduit to inhibit egress of transferred liquid from the outlet until the elevated delivery pressure is generated.

3. A vaporizer as claimed in claim 1 wherein the pumping system also pressurizes the liquid to generate the elevated delivery pressure.

4. A vaporizer as claimed in claim 1 wherein the pumping system comprises a pair of pistons, each mounted for reciprocation within an associated pump chamber forming the reservoir and connected to a drive to operate with pump strokes having a relative phase difference of substantially 180 degrees.

5. A vaporizer as claimed claim 1 wherein the heater supplies thermal energy in an amount to heat the liquid within the delivery conduit to a temperature of at least the boiling point of the liquid at a pressure externally of the outlet.
